(19) United States
(12) Patent Application Publication
(10) Pub. No.: US 2011/0040899 A1
(43) Pub. Date: Feb. 17, 2011

(54) HOST/PERIPHERAL LOCAL INTERCONNECT THAT IS COMPATIBLE WITH SELF-CONFIGURABLE PERIPHERAL DEVICE

(76) Inventors: Roberto Gabriel Yepez, San Francisco, CA (US); Josh Graessley, Sunnyvale, CA (US); Paul Chinn, San Jose, CA (US); Anand Dalal, Cupertino, CA (US)

Correspondence Address: BLAKELY, SOKOLOFF, TAYLOR & ZAFMAN LLP, 1279 Oakmead Parkway, Sunnyvale, CA, 94085-4040, US

(21) Appl. No.: 12/541,107

(22) Filed: Aug. 13, 2009

(51) Int. Cl. G06F 3/00

(52) U.S. Cl. 710/10

(57) ABSTRACT

A host/peripheral local interconnect that is compatible with a self-configurable peripheral device is described. According to processes discussed herein, the peripheral device is self-configured. The host device may be kept aware of the self-configured state of the peripheral device, and/or self-configured changes made at the peripheral device. The host device may scale its applications/uses of the peripheral device in light of such awareness.

### FIELD OF THE INVENTION

The field of invention relates generally to computing systems, and, more specifically, to a host/peripheral local interconnect that is compatible with a self-configurable peripheral device.

### BACKGROUND

FIGS. 1A and 1B pertain to prior art configuration mechanisms for “peripheral” devices that are capable of being communicatively coupled to a “host” device. Traditionally, peripheral devices included handheld devices having modest functionality/intelligence. Examples include handheld music players (e.g. MP3 players), non-volatile memory sticks, personal digital assistants (PDAs) and cell phones. The host device was typically some kind of computer such as a personal computer (PC), laptop or notebook computer. The interconnection 103 between the host 101 and the peripheral device 102 has traditionally been implemented with some form of local interconnect such as a Universal Serial Bus (USB).

Peripheral devices typically include a plurality of different operating modes (or “configurations”) that describe the “services” the peripheral is capable of offering, for example, a Personal Digital Assistant (PDA) device might offer: 1) a digital camera mode, and, 2) a digital camera mode and contact/calendar mode. In configuration 1) above, the peripheral behaves only as a digital camera, whereas, in configuration 2) above, the peripheral behaves as both a digital camera and contact/calendar device. At least when connected to the host 101, the selection of a particular operating mode for the peripheral 102 has been traditionally controlled by the host 101 in a master-slave arrangement. That is, the host 101 determined and established a particular configuration setting for the peripheral 102 which thereafter operated according to the particular setting mandated by the host 101.

Here, perhaps because the functionality of the peripheral 102 was limited, and/or, the user interface of the peripheral 102 was not as easy to use as that of the host 101, the design point was hinged on the assumption that it was easier and/or more practical to configure the peripheral 102 from/through the host 101 rather than at the peripheral 102 itself.

FIG. 1B provides an example. According to FIG. 1B, the host first detects 110 the presence of the peripheral device. For example, in the case of a USB local interconnect, the host 101 detects that the peripheral device 102 is connected to the end of the USB cable that is opposite the end to which the host 101 is connected. After the host 101 has detected the presence of the peripheral 102, the host queries 111 the peripheral device 102 for the different configuration settings that the peripheral device 102 supports. For instance, in the case of a USB local interconnect 103, the host 101 sends a “GET_DESCRIPTOR” command (for the type “CONFIGURATION”) to the peripheral 102.

In response, the peripheral 102 sends 112 to the host device 101 a list of the various configuration settings that the peripheral device supports. For example, if the peripheral device 102 supports both “digital camera only” mode (mode 1 described above) and “digital camera and contact/calendaring” mode (mode 2 described above), the peripheral device would respond to the GET DESCRIPTOR command by sending to the host device 101 a list that included both of these modes. With knowledge of the supported modes of the peripheral 102, the host 101 selects one of these modes (e.g., by way of a user selection through a Graphical User Interface (GUI) that is presented on the display of the host 101) and sends a command over the USB to the peripheral that configures the peripheral according to the selected mode (e.g., with a SET_CONFIGURATION command). The prior art USB local interconnect also supports a command (GET_CONFIGURATION) in which the host device asks the peripheral device outright for its current configuration.

Recently, peripheral devices have become more and more intelligent and sophisticated including easier to use user interfaces (e.g., smart phones). As a consequence, not being able to configure a peripheral device from the peripheral device itself when the peripheral device is communicatively coupled to the host is becoming a less natural usage case. Unfortunately, the underlying local interconnect technologies (such as USB) were designed prior to the emergence of sophisticated peripherals, and, correspondingly, the communication protocols of these local interconnects do not contemplate the ability of a peripheral to configure itself. For instance, the applicable USB standards do not provide for an explicit communication from the peripheral to the host that informs the host that the peripheral has configured itself into a particular operating mode.

### SUMMARY OF THE INVENTION

A host/peripheral local interconnect that is compatible with a self-configurable peripheral device is described. According to processes discussed herein, the peripheral device is self-configured. The host device may be kept aware of the self-configured state of the peripheral device, and/or self-configured changes made at the peripheral device. The host device may scale its applications/uses of the peripheral device in light of such awareness.

### BRIEF DESCRIPTION OF THE DRAWINGS

The present invention is illustrated by way of example and not limitation in the figures of the accompanying drawings, in which like references indicate similar elements and in which:

FIG. 1a shows a host, peripheral device and local interconnect;

FIG. 1b shows a prior art peripheral device configuration process executed between a host and peripheral device;

FIG. 2 shows an improved peripheral device configuration process executed between a host and peripheral device;

FIG. 3 shows a second improved peripheral device configuration process executed between a host and peripheral device;

FIG. 4 shows a configuration architecture for a self-configurable peripheral device;

FIG. 5 shows an embodiment of a computing system.

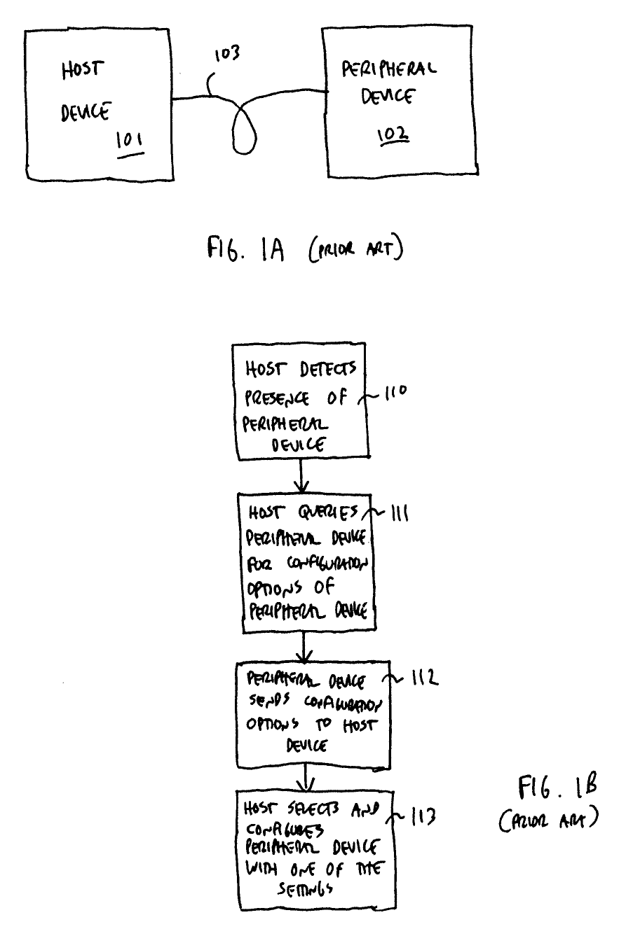

### DETAILED DESCRIPTION

Given that the emergence of more sophisticated peripherals has caused user experiences to more naturally expect that a peripheral device should be able to be configured from the peripheral side even if the peripheral is communicatively coupled to a host through a local interconnect, it behooves system designers to provide for such an environment. Unfortunately, legacy local interconnect technologies (such as USB): 1) are not presently understood to possess communication protocols that fully contemplate self-configurable peripherals, and, 2) are not expected to be replaced in the near future. As such, in order to preserve downward compatibility with existing local interconnects yet embrace self-configurable peripherals, an approach that successfully implements self-configurable peripherals over such existing local interconnects is needed. That having been said, it should be understood that the techniques disclosed herein are equally applicable to local interconnects that do embrace self-configurable peripherals should such local interconnects eventually emerge.

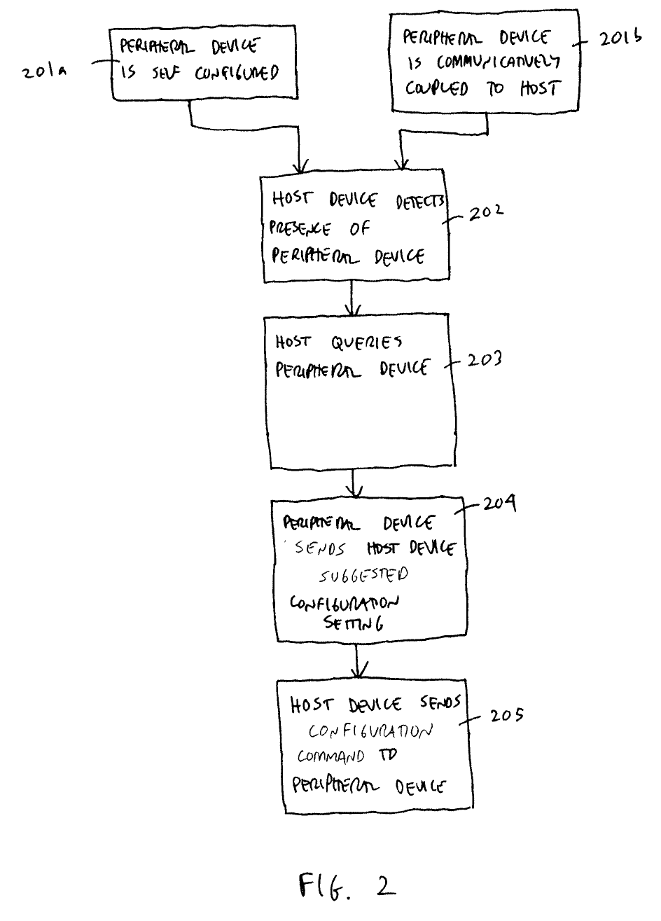

FIG. 2 shows an embodiment of a process that contemplates a self-configurable peripheral. Here “self configurable” means that the setting of a configuration mode of the peripheral is initiated at the peripheral. Examples include an automatic configuration change imposed by decision making performed with software executed on the peripheral and/or a change imposed by a user of the peripheral through a user interface of the peripheral. According to the process of FIG. 2, a peripheral is self configured 201a and is communicatively coupled to a host device 201b. The host device detects 202 the presence of the peripheral. The host device then queries 203 the peripheral.

According to the embodiment of FIG. 2 where the underlying local interconnect is a traditional USB bus, the query 203 takes the form of a command that asks the peripheral for a configuration mode of the peripheral that the peripheral recognizes as being appropriate (e.g., for the peripheral's current situation/surroundings). The peripheral then responds 204 to the query by providing the host with the requested configuration setting of the peripheral. In a sense, the host asks the peripheral what it “thinks” the best configuration mode for itself is, and, in response, the peripheral suggests a specific configuration mode to the host. In an embodiment, the host request and peripheral response are implemented as USB “vender specific” commands.

With the host being informed of the suggested peripheral configuration setting the host can next determine if the suggested peripheral configuration setting is appropriate for the host. For example, if the peripheral sends a suggested configuration setting that includes a digital camera and the host has not enabled its software for use with a digital camera peripheral, the host can, for example, enable such software and then accept the peripheral's suggestion, or, can request the peripheral to send alternative configuration settings.

In the former case (the host accepts the peripheral's suggestion), in an embodiment, the host signifies its acceptance of the peripheral's suggestion by sending a command 205 (e.g., a SET_CONFIGURATION command in the case of a USB local interconnect) to the peripheral to effect the suggested configuration setting at the peripheral. In this case it is possible that the peripheral's suggested configuration was its current configuration setting. As such, the command from the host simply instructs the peripheral to enter its current configuration setting—which the peripheral is free to ignore.

In the later case (the host asks the peripheral for additional configuration settings), the host selects which of the additional configuration settings it prefers and instructs the peripheral to enter that configuration 205. If the peripheral's suggested configuration setting was its current configuration setting, then, the command from the host would cause the peripheral to change its configuration state from the current/suggested state to the configuration state commanded by the host. Note that in the case of a USB local interconnect the host can ask for the alternative peripheral configuration settings with a GET_DESCRIPTOR command of type CONFIGURATION.

Note that, according to at least some implementations, the peripheral's configuration could be changed while the peripheral is communicatively coupled to the host through the local interconnect. For instance, consider a peripheral that has the following configuration possibilities: 1) a camera mode (in which the peripheral behaves principally as a digital camera); 2) a camera and “PDA” mode (in which the peripheral behaves principally as a combined camera, music player (including access to an on line music service such as iTunes) and calendaring/contacts device and can also synchronize/install/configure/debug software applications on its own or at the control of the host); 3) a camera/PDA/tethering mode (in which the peripheral behaves as described above with respect to the “camera and PDA” mode but can also support the “tethering” of network traffic for the host); and 4) an audio mode (in which the smartphone behaves principally as a music player including access to an on line music service). Note that tethering is a situation in which the peripheral devices acts as a network interface for the host device. For example, if the peripheral device is a smart phone, the host is able to “surf” the Internet by using the smart phone and its wireless network as an access mechanism to send/receive information to/from the Internet. It is worthwhile to note the wealth of different “services” that a smartphone can provide (camera, calendaring/contacts, tethering and synchronization/installation/configuration/debugging of software), and, that the different configuration settings can be, as described above, different combinations/sets of the different services offered by the smartphone.

In the case of peripheral smart phones having multiple configuration setting possibilities, such as those described above, conceivably, the peripheral could leave any of the multiple configuration modes to enter any of the other modes while the peripheral is communicatively coupled to the host. Again, because traditional local interconnects such as a USB do not fully contemplate self-configurable peripherals, legacy communication protocols of such local interconnects do not readily provide for a communication from a peripheral to a host for the purpose of explicitly telling the host that the peripheral's configuration mode has changed into a new mode (because, again, the configuration of a peripheral has traditionally been under the exclusive control of the host).

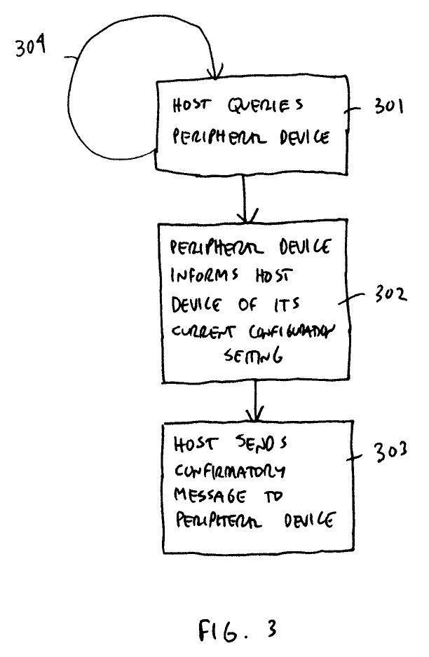

FIG. 3 shows a scheme that permits a host to become aware of dynamic configuration mode changes that occur at the peripheral even though a legacy local interconnect is being used to connect to the host. According to the methodology depicted in FIG. 3, the host device periodically 304 queries 301 the peripheral device. By periodically querying the peripheral device, the host device will be made aware of any configuration changes made at the peripheral device.

As an example, consider a situation in which the peripheral is a smart phone that is in the third “camera/PDA/tethering” mode discussed above. With knowledge that the peripheral is within this mode of operation, the host will understand that, for example, the host is not only free to exchange digital photographs and contact/calendar information with the peripheral, but also is free to “teather” through the peripheral device (among other engagements with the peripheral consistent with the camera/PDA/tethering mode discussed above). If the smart phone suddenly detects that its connection with its wireless network is down (or the user commands the smart phone to enter a mode such as “airplane mode” that causes the smart phone to disable its wireless network radio circuitry), the smart phone is apt to drop from the “camera/PDA/tethering” mode to the “camera” mode. Without knowledge of this event, the host could mistakenly initiate tethering service with the smart phone even though such service is no longer available.

However, by repeatedly 304 querying 301 the smart phone as to its current configuration status, the host will “catch” any such configuration changes made at the peripheral end. In this specific example, the host will realize that the smart phone is no longer capable of offering tethering services and will therefore prevent or otherwise not initiate a tethering session through the peripheral.

Likewise, the reverse is also possible. That is, should the smart phone re-connect with its wireless network, it will jump up from the “camera” mode to the “camera/PDA/tethering” mode. With knowledge of this change through its repeated querying of the smart phone's configuration, the host will realize that tethering services are no longer unavailable and will likewise not squelch a next attempt to tether through the smart phone.

FIG. 3 also demonstrates that the exchange between the periodically querying host and the dynamically changing smart phone could be based on the process discussed above with respect to FIG. 2. That is, for example, in the case of a USB local interconnect, the host repeatedly queries the peripheral with the command described above that requests the peripheral for a suggested peripheral configuration (where the suggested configuration is the current peripheral setting). Alternatively, in the case of a USB local interconnect, a GET_CONFIGURATION command could be used. The peripheral then responds 302 to each query with its current configuration. The host then sends a message 303 back to the peripheral that confirms the peripheral is to be in its current configuration mode.

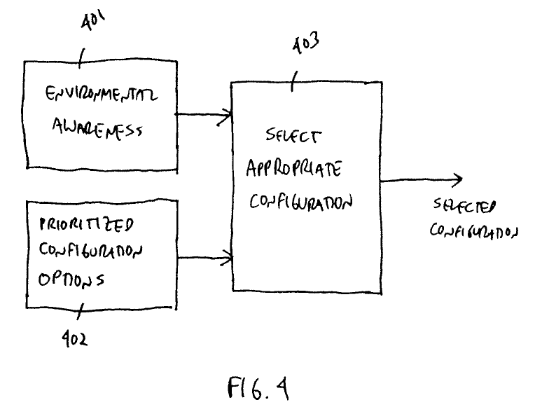

FIG. 4 shows a self-configuration architecture for a peripheral such as a smart phone that is capable of initiating its own configuration change even when the peripheral is communicatively coupled to a host through a local interconnect. The architecture of FIG. 4 could be implemented in software (through execution of program code instructions), hardware (with dedicated circuitry) or some combination thereof. According to the architecture of FIG. 4 there exists an environmental-awareness mechanism 401 and a prioritized list of configuration states 402. A selection mechanism 403 selects the highest prioritized configuration that is feasible in view of the current environment. For example, using the aforementioned example in which the wireless network of a smart phone suddenly becomes unavailable, the environmental-awareness mechanism 401 will detect and/or report that the wireless network is no longer available. The prioritized list 402 may list the following configuration states in order of priority: 1) camera/PDA/tethering (highest priority); 2) camera/PDA (second highest priority); 3) audio, and, 4) camera (lowest priority). Here, the prioritization scheme essentially reflects that the highest possible performance capabilities of the smart phone under the circumstances should be chosen.

The selection mechanism will therefore select the camera mode (mode #4 above) because that is the highest priority mode that is feasible when the wireless network is not available (note the PDA and audio modes expect a working on line music service such as iTunes). Note that configuration settings imposed by a user through the smart phone's user interface can be picked up through the environmental-awareness mechanism 401. For example, if the user disables the smart phone's wireless radio circuitry—e.g., by causing the smart phone to enter “airplane mode”—the environmental-awareness mechanism will detect/report that the wireless radio circuitry has been disabled and/or that the user has specified airplane mode. Regardless as to how this environmental change is reported, the selection mechanism will be able to determine that tethering is not possible, but camera functions are possible. In view of this environmental condition, the selection mechanism will scan the prioritized list 403 of configuration states for the highest prioritized and feasible configuration state (in this example, the camera configuration mode).

It is pertinent to point out that, although the above examples principally relied on USB as the local interconnect, other local interconnects may readily be used such as Bluetooth or Firewire. Here, note that a number of local interconnects are point-to-point connect connections between a host and a peripheral where the peripheral is not mechanically integrated with the host. These are to be contrasted against, for example, memory sticks, adapter cards or other “peripherals” that are mechanically integrated with the host (e.g., by being plugged into the host device) and communicatively coupled with the host through a multi-drop bus that can carry signals of multiple peripherals (rather than a point-to-point connection that can only entertain the signaling two/from a single peripheral)

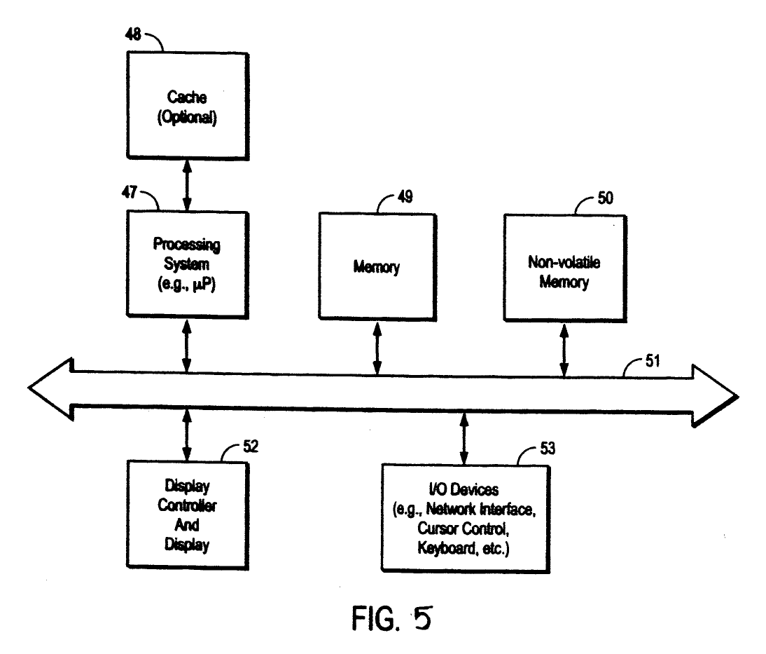

FIG. 5 shows one example of a typical computing system (or “computer system”) which may be used with the present invention. Note that while FIG. 5 illustrates various components of a computer system, it is not intended to represent any particular architecture or manner of interconnecting the components as such details are not germane to the present invention. For example, the architecture of FIG. 5 may apply to either or both of the above described host and peripheral devices. It will also be appreciated that smart phones, personal digital assistants (PDAs), cellular telephones, handheld computers, media players (e.g. an iPod), entertainment systems, devices which combine aspects or functions of these devices (e.g. a media player combined with a PDA and a cellular telephone in one device), an embedded processing device within another device, network computers, a consumer electronic device, and other data processing systems which have fewer components or perhaps more components may also be used with or to implement one or more embodiments of the present invention. The computer system of FIG. 5 may, for example, be a Macintosh computer from Apple Inc. The system may be used when programming or when compiling or when executing the software described.

As shown in FIG. 5, the computer system 45, which is a form of a data processing system, includes a bus 51 which is coupled to a processing system 47 and a volatile memory 49 and a non-volatile memory 50. The processing system 47 may be a microprocessor from Intel which is coupled to an optional cache 48. The bus 51 interconnects these various components together and also interconnects these components to a display controller and display device 52 and to peripheral devices such as input/output (I/O) devices 53 which may be mice, keyboards, modems, network interfaces, printers and other devices which are well known in the art. Typically, the input/output devices 53 are coupled to the system through input/output controllers. The volatile memory 49 is typically implemented as dynamic RAM (DRAM) which requires power continually in order to refresh or maintain the data in the memory. The nonvolatile memory 50 is typically a magnetic hard drive, a flash semiconductor memory, or a magnetic optical drive or an optical drive or a DVD RAM or other types of memory systems which maintain data (e.g. large amounts of data) even after power is removed from the system. Typically, the nonvolatile memory 50 will also be a random access memory although this is not required.

While FIG. 5 shows that the nonvolatile memory 50 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 51 may include one or more buses connected to each other through various bridges, controllers and/or adapters as is well known in the art.

It will be apparent from this description that aspects of the present invention may be embodied, at least in part, in software. That is, the techniques may be carried out in a computer system or other data processing system in response to its processor, such as a microprocessor, executing sequences of instructions contained in a machine readable storage medium such as a memory (e.g. memory 49 and/or memory 50). In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the processing system 47.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A method, comprising:
executing the following at a host device that is communicatively coupled to a peripheral device through a local interconnect, said peripheral device not mechanically integrated with said host, said local interconnect being a point-to-point connection between said host and said peripheral device:
querying said peripheral device for said peripheral device's suggested configuration; and,
receiving from said peripheral device said peripheral device's suggested configuration.

2. The method of claim 1 wherein said peripheral device is capable of communicating over a wireless network.

3. The method of claim 1 wherein said local interconnect is Bluetooth (BT).

4. The method of claim 1 wherein said local interconnect is Universal Serial Bus (USB).

5. The method of claim 1 wherein said received configuration is said peripheral device's current configuration.

6. A method, comprising:
a) self configuring a peripheral device; and,
b) executing the following at said peripheral device, said peripheral device not being mechanically integrated with a host device, said peripheral device being communicatively coupled to said host device through a point-to-point local interconnect:
receiving a query from said host device that requests said peripheral device to provide a suggested configuration for said peripheral;
sending to said host device a suggested configuration for said peripheral device; and,
receiving from said peripheral device a message that specifies said peripheral device's current configuration.

7. The method of claim 6 wherein said self configuring of said peripheral device comprises:
generating a characterization of said peripheral device's environment;
selecting a configuration amongst a plurality of configurations for said peripheral device, said selected configuration having a highest priority amongst those of said configurations that are compatible with said characterization.

8. The method of claim 7 wherein said characterization specifies any of:
whether said peripheral device includes a camera;
whether said peripheral device can receive calendar and/or contact information
whether said peripheral device supports tethering to a wireless network.

9. The method of claim 6 wherein said peripheral device is capable of communicating over a wireless network.

10. The method of claim 6 wherein said local interconnect is Bluetooth (BT).

11. The method of claim 6 wherein said local interconnect is Universal Serial Bus (USB).

12. A device comprising a processing unit and a storage medium, said storage medium containing program code to be processed by said processing unit to perform a method, said method comprising:
a) self configuring said device; and,
b) executing the following at said device, said device being communicatively coupled to a host device:
receiving a query from said host device that requests a suggested configuration setting for said device, said device having configuration settings that include different sets of the following services:
i) a digital camera;
ii) a music player;
iii) changing contact information and calendaring;
iv) tethering;
sending to said host device a suggested configuration setting for said device.

13. The device of claim 12 wherein said self configuring of said peripheral device comprises:
generating a characterization of said peripheral device's environment;
selecting a configuration amongst a plurality of configurations for said peripheral device, said selected configuration having a highest priority amongst those of said configurations that are compatible with said characterization.

14. The device of claim 13 wherein said characterization specifies any of:
whether said peripheral device includes a camera;
whether said peripheral device can receive calendar and/or contact information;
whether said peripheral device supports tethering to a wireless network.

15. The device of claim 12 wherein said peripheral device is capable of communicating over a wireless network.

16. The device of claim 12 wherein said local interconnect is Bluetooth (BT).

17. The device of claim 12 wherein said local interconnect is Universal Serial Bus (USB).

18. The device of claim 12 wherein said message is a configuration command.

19. A method, comprising:
detecting, at a host computer, that a peripheral device is communicatively coupled to said host through a local interconnect;
detecting at said host device that said peripheral device has self configured such that said peripheral device is capable of supporting tethering services for said host;
tethering from said host through said peripheral device;
detecting at said host device that said peripheral device has self configured such that said peripheral device is no longer capable of supporting tethering services for said host; and,
refusing to initiate tethering through said peripheral device in response to said detecting that said peripheral device is no longer capable of supporting tethering services.

20. The method of claim 19 wherein said tethering comprises receiving information from the Internet through a wireless network that said peripheral device is connected to.

21. The method of claim 20 wherein said peripheral device is a smart phone.

22. The method of claim 21 wherein said local interconnect is one of:
a USB local interconnect;
a Bluetooth local interconnect.

23. A machine readable storage medium containing program code that when processed by a processing unit cases a method to be performed, said method comprising:
executing the following at a host device that is communicatively coupled to a peripheral device through a local interconnect, said peripheral device not mechanically integrated with said host, said local interconnect being a point-to-point connection between said host and said peripheral device:
querying said peripheral device for said peripheral device's suggested configuration; and,
receiving from said peripheral device said peripheral device's suggested configuration.

24. The method of claim 1 wherein said local interconnect is Bluetooth (BT).

25. The method of claim 1 wherein said local interconnect is Universal Serial Bus (USB).
